(19) United States
(12) Patent Application Publication
(10) Pub. No.: US 2026/0062007 A1
(43) Pub. Date: Mar. 5, 2026

(54) DRIVING ASSISTANCE SYSTEM, DRIVING ASSISTANCE METHOD, AND STORAGE MEDIUM THEREOF

(71) Applicant: J-QuAD DYNAMICS Inc., Tokyo (JP)

(72) Inventors: YUKI YAMAMOTO, Tokyo (JP); KOJI SHIBATA, Tokyo (JP); YUKA SATRE, Tokyo (JP); NOBUYUKI IMODA, Tokyo (JP)

(21) Appl. No.: 19/310,516

(22) Filed: Aug. 26, 2025

(30) Foreign Application Priority Data
Aug. 29, 2024 (JP) 2024-147383

(51) Int. Cl. B60W 30/18; B60W 30/09; B60W 30/095; B60W 50/00

(52) U.S. Cl. CPC B60W 30/181; B60W 30/09; B60W 30/0956; B60W 30/18154; B60W 50/0097; B60W 2050/0083; B60W 2554/4029

(57) ABSTRACT

A driving assistance system assists a driving of a host vehicle with respect to other road users. The driving assistance system includes at least one processor with a memory storing computer program code. The at least one processor with the memory is configured to cause the driving assistance system to: schedule a temporary stop of the host vehicle in a cruise control state; monitor an interference area where the host vehicle is predicted to cause an interference to other road users due to a temporary stop on a travel route in the cruise control state; and set a stop control command to control the host vehicle to make a temporary stop on the travel route before the host vehicle enters the interference area.

### CROSS REFERENCE TO RELATED APPLICATION

The present application claims the benefit of priority from Japanese Patent Application No. 2024-147383 filed on Aug. 29, 2024. The entire disclosure of the above application is incorporated herein by reference.

### TECHNICAL FIELD

The present disclosure relates to a driving assistance technology that assists driving of a host vehicle.

### BACKGROUND

There has been known driving assistance technology that warns a driver of a host vehicle when the host vehicle has a high possibility of making a temporary stop in a no stopping zone.

### SUMMARY

According to an aspect of the present disclosure, a driving assistance system assists a driving of a host vehicle with respect to other road users. The driving assistance system includes at least one processor with a memory storing computer program code. The at least one processor with the memory may be configured to cause the driving assistance system to: schedule a temporary stop of the host vehicle in a cruise control state; monitor an interference area where the host vehicle is predicted to cause an interference to other road users due to a temporary stop on a travel route in the cruise control state; and set a stop control command to control the host vehicle to make a temporary stop on the travel route before the host vehicle enters the interference area.

### BRIEF DESCRIPTION OF DRAWINGS

Features of the present disclosure will become apparent from the following detailed description made with reference to the accompanying drawings. In the drawings:

FIG. 1 is a block diagram showing a physical configuration of a driving assistance system according to an embodiment of the present disclosure;

FIG. 2 is a schematic diagram showing a traveling environment of a host vehicle to which one embodiment is applied;

FIG. 3 is a block diagram showing a functional configuration of a driving assistance system according to an embodiment of the present disclosure;

FIG. 4 is a flowchart showing a driving assistance flow according to an embodiment of the present disclosure;

FIG. 5 is a schematic diagram for explaining a driving assistance flow according to an embodiment of the present disclosure;

FIG. 6 is a schematic diagram for explaining a driving assistance flow according to an embodiment of the present disclosure;

FIG. 7 is a schematic diagram for explaining a driving assistance flow according to an embodiment of the present disclosure;

FIG. 8 is a schematic diagram for explaining a driving assistance flow according to an embodiment of the present disclosure;

FIG. 9 is a schematic diagram for explaining a driving assistance flow according to an embodiment of the present disclosure;

FIG. 10 is a schematic diagram for explaining a driving assistance flow according to an embodiment of the present disclosure;

FIG. 11 is a schematic diagram for explaining a driving assistance flow according to an embodiment of the present disclosure;

FIG. 12 is a schematic diagram for explaining a driving assistance flow according to an embodiment of the present disclosure;

FIG. 13 is a schematic diagram for explaining a driving assistance flow according to an embodiment of the present disclosure;

FIG. 14 is a schematic diagram for explaining a driving assistance flow according to an embodiment of the present disclosure;

FIG. 15 is a schematic diagram for explaining a driving assistance flow according to an embodiment of the present disclosure;

FIG. 16 is a schematic diagram for explaining a driving assistance flow according to an embodiment of the present disclosure;

FIG. 17 is a schematic diagram for explaining a driving assistance flow according to an embodiment of the present disclosure; and

FIG. 18 is a schematic diagram for explaining a driving assistance flow according to an embodiment of the present disclosure.

### DETAILED DESCRIPTION

In a related art, when no stopping zone is preliminarily defied within a railroad crossing or an intersection, prevention of stopping in such a no stopping zone is entrusted to the driving operation of the driver. When the technology disclosed in the related are is applied to a cruise control of the host vehicle, it is difficult to automatically control the host vehicle to make a temporary stop with consideration of a predicted interference to be caused by the host vehicle to other road users.

According to a first aspect of the present disclosure, a driving assistance system assists a driving of a host vehicle with respect to other road users. The driving assistance system includes at least one processor with a memory storing computer program code. The at least one processor with the memory is configured to cause the driving assistance system to: schedule a temporary stop of the host vehicle in a cruise control state; monitor an interference area where the host vehicle is predicted to cause an interference to other road users due to a temporary stop on a travel route in the cruise control state; and set a stop control command to control the host vehicle to make a temporary stop on the travel route before the host vehicle enters the interference area.

According to a second aspect of the present disclosure, a driving assistance method is executed by at least one processor to assist a driving of a host vehicle with respect to other road users. The driving assistance method includes scheduling a temporary stop of the host vehicle in a cruise control state; monitoring an interference area where the host vehicle is predicted to cause an interference to other road users due to a temporary stop on a travel route in the cruise control state; and setting a stop control command to control the host vehicle to make a temporary stop on the travel route before the host vehicle enters the interference area.

According to a third aspect of the present disclosure, a computer-readable non-transitory storage medium stores a driving assistance program for assisting a driving of a host vehicle with respect to other road users. The driving assistance program includes instructions for causing at least one processor to: schedule a temporary stop of the host vehicle in a cruise control state; monitor an interference area where the host vehicle is predicted to cause an interference to other road users due to a temporary stop on a travel route in the cruise control state; and set a stop control command to control the host vehicle to make a temporary stop on the travel route before the host vehicle enters the interference area.

In the first to third aspects, the temporary stop of host vehicle is scheduled in the cruise control state. Therefore, the interference area, where an interference may be caused by the host vehicle to other road users due to the temporary stop, is monitored while the host vehicle travels on the travel route by performing the cruise control. With this configuration, the stop control command can be set for the host vehicle while the host vehicle travels in the cruise control state. The stop control command controls the host vehicle to make the temporary stop on the travel route before entering the interference area. Thus, the host vehicle can automatically make the temporary stop with consideration of the interference with other road users.

The following will describe an embodiment of the present disclosure with reference to the accompanying drawings.

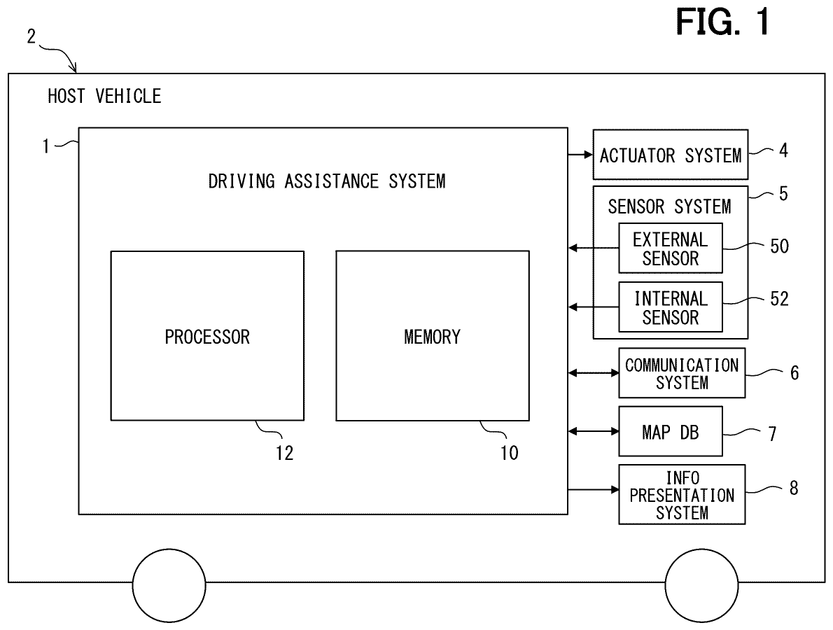

A driving assistance system 1 according to one embodiment of the present disclosure is shown in FIG. 1. The driving assistance system 1 assists a driving operation of a host vehicle 2. At least a part of the driving assistance system 1 is installed in the host vehicle 2. The host vehicle 2 to which the driving assistance system 1 is applied is capable of achieving a level of automated driving defined, for example, in SAE J3016. In SAE J3016, in addition to automated driving tasks, manual driving assistance tasks that assist the operator in manual driving operations are also defined.

The host vehicle 2 is a road user, such as an automobile, a truck, or a bus, and may be referred to as an ego vehicle. In the present embodiment, an occupant who is seated in a seat inside the host vehicle 2 and is able to perform a manual driving operation is also referred to as a host occupant, and corresponds to a target of the driving assistance provided by the driving assistance system 1.

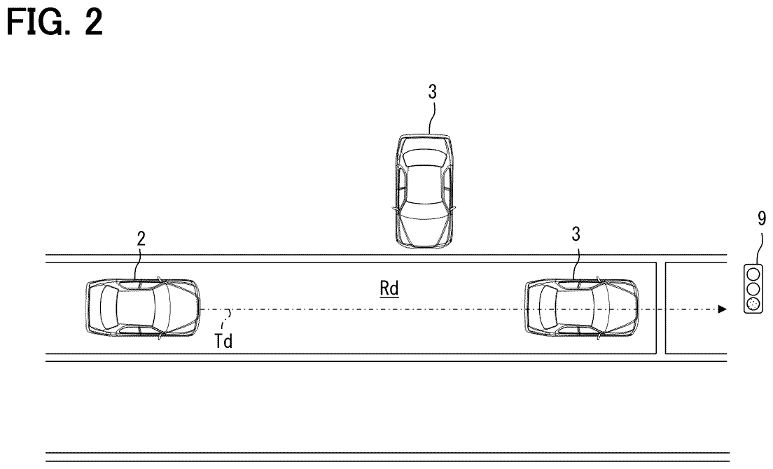

As shown in FIG. 2, in a driving environment of the host vehicle 2, a traffic scene may include other road users 3 in addition to the host vehicle 2. The other road users 3 include vulnerable road users and non-vulnerable road users. The vulnerable road users and the non-vulnerable road users are defined according to the vulnerability. The vulnerable road users may include humans, for example, pedestrians, runners, or the like. The non-vulnerable road users may be at least one type of a vehicle with human occupants, such as, automobiles, trucks, buses, motorcycles, and bicycles.

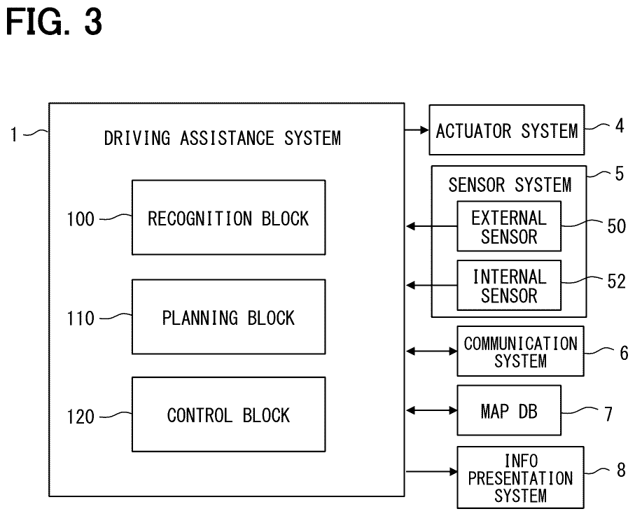

As shown in FIG. 1 and FIG. 3, the host vehicle 2 is equipped with an actuator system 4, a sensor system 5, a communication system 6, a map database (DB) 7, and an information presentation system 8 together with at least a part of the driving assistance system 1. FIG. 1 representatively shows an example in which the entire part of driving assistance system 1 is implemented in the form of a driving assistance device mounted on the host vehicle 2. The driving assistance device may be implemented by a control device (for example, a control ECU) or a semiconductor device (for example, a semiconductor chip).

The actuator system 4 shown in FIG. 1 and FIG. 3 is configured to be able to control the host vehicle 2 based on a control command output from the driving assistance system 1. The actuator system 4 may be at least one type of power train actuator of, for example, an internal combustion engine, a motor generator motor, or the like. The actuator system 4 may be at least one type of brake actuator of, for example, a brake unit or the like. The actuator system 4 may be at least one type of steering actuator of, for example, a power steering unit or the like. The actuator system 4 may be at least one type of light emitting actuator, for example, a headlight unit, a direction indicator, or the like.

The sensor system 5 senses external and internal environments of the host vehicle 2 to obtain sensing information that can be used in the driving assistance system 1. For this purpose, the sensor system 5 includes an external sensor 50 and an internal sensor 52.

The external sensor 50 senses targets existing in the external environment of the host vehicle 2. The external sensor 50 of target sensing type is at least one of a vehicle-mounted camera, a LiDAR (light detection and ranging/laser imaging detection and ranging), a laser sensor, a millimeter wave sensor, a sonar sensor, or the like. The external sensor 50 of target sensing type may be implemented in a combined manner by combining different types of sensors so as to be capable of sensing front direction, lateral direction, and rear direction of the host vehicle 2.

The internal sensor 52 senses a specific physical quantity of motion related to vehicle motion in the internal environment of the host vehicle 2. The internal sensor 52 of motion sensing type is at least one of a speed sensor, an acceleration sensor, a gyro sensor, an inertial sensor, or the like. The internal sensor 52 may sense an operation and/or a state of the occupant in the host vehicle 2. The internal sensor 52 of occupant sensing type may be at least one of an accelerator pedal sensor, a brake pedal sensor, a shift sensor, a steering angle sensor, a steering torque sensor, an occupant camera, an occupant seat switch, a gesture sensor, a biometric sensor, or a seating sensor.

The communication system 6 acquires communication information to be used in the driving assistance system 1 via a communication network. The communication system 6 may receive a positioning signal from an artificial satellite of a global navigation satellite system (GNSS) existing in the outside of the host vehicle 2. The communication system 6 of positioning type is, for example, a GNSS receiver or the like. The communication system 6 may transmit and receive a communication signal to and from a V2X system located outside of the host vehicle 2. The communication system 6 of V2X communication type is at least one of, for example, a dedicated short range communications (DSRC) communication device, a cellular V2X (C-V2X) communication device, or the like. The communication system 6 may transmit and receive communication signals to and from a mobile terminal existing in the internal environment of the host vehicle 2. The communication system 6 of terminal communication type is at least one of, for example, Bluetooth (registered trademark) device, Wi-Fi (registered trademark) device, infrared communication device, or the like.

The map DB 7 stores map information that can be used in the driving assistance system 1. The map DB 7 is implemented by at least one of a non-transitory tangible storage medium, such as a semiconductor memory, a magnetic medium, an optical medium, or the like. The map DB 7 may be a DB of a locator that estimates a self-position of the host vehicle 2. The map DB may be a DB of navigation unit that navigates a travel route of the host vehicle 2. The map DB 7 may be constructed by a combination of multiple types of DBs.

The map DB 7 downloads digital maps as necessary, for example, by performing via V2X communication with an external center via the communication system 6, and updates the map information. The map information is converted into two-dimensional or three-dimensional data as information representing the external environment in which the host vehicle 2 is traveling. As the three-dimensional map information, digital data of a high-precision map may be adopted. The map information includes road information that indicates at least one of locations, shapes, sizes of the road. The map information may include structure information that indicates at least one of positions, shapes, and sizes of buildings and traffic lights facing the road. The map information may include road marking information that indicates at least one of positions, shapes, sizes of signs and road markings of the road.

The information presentation system 8 presents notification information to an occupant of the host vehicle 2. The information presentation system 8 presents notification information to the occupant of the host vehicle 2 by stimulating a visual sense of the occupant. The information presentation system 8 of visual type is at least one of an electronic mirror unit, a monitor unit, a navigation unit, a HUD (head-up display) unit, an illumination unit, or the like. The information presentation system 8 may present the notification information by stimulating auditory sense of the occupant. The information presentation system 8 of the auditory information presentation type is, for example, at least one of a speaker, a buzzer, a vibration unit, or the like.

The driving assistance system 1 is connected to the actuator system 4, the sensor system 5, the communication system 6, the map DB 7, and the information presentation system 8 via at least one type of, for example, a local area network (LAN), a wire harness, an internal bus, a wireless communication line, or the like. The driving assistance system 1 is implemented by at least one dedicated computer.

The dedicated computer constituting the driving assistance system 1 may be an integrated Electronic Control Unit (ECU) that integrally controls the driving of the host vehicle 2. The dedicated computer constituting the driving assistance system 1 may be a sensing ECU that processes sensing information in driving control of the host vehicle 2. The dedicated computer constituting the driving assistance system 1 may be a recognition ECU that recognizes the external environment in driving control of the host vehicle 2. The dedicated computer constituting the driving assistance system 1 may be a locator ECU that estimates the self-position of the host vehicle 2.

The dedicated computer constituting the driving assistance system 1 may be a planning ECU that plans the driving control of the host vehicle 2. The dedicated computer constituting the driving assistance system 1 may be a navigation ECU that navigates a traveling route in driving control of the host vehicle 2. The dedicated computer constituting the driving assistance system 1 may be an actuator ECU that controls the actuator system 4 as part of driving control of the host vehicle 2. The dedicated computer constituting the driving assistance system 1 may be an information management ECU that controls the information presentation system 8 as part of driving control of the host vehicle 2. The dedicated computer constituting the driving assistance system 1 may be at least one external computer that constructs an external center or a mobile terminal which is able to perform communication via the communication system 6.

The dedicated computer constituting the driving assistance system 1 has at least one memory 10 and at least one processor 12 as shown in FIG. 1. The memory 10 is provided by a computer-readable non-transitory tangible storage medium, such as a semiconductor memory, a magnetic medium, or an optical medium, and stores computer-readable program and data. The processor 12 includes, as a core, at least one type of, for example, a central processing unit (CPU), a graphics processing unit (GPU), a reduced instruction set computer (RISC)-CPU, or the like.

The processor 12 executes multiple instructions included in a processing program stored in the memory 10 as software. As a result, the driving assistance system 1 constructs multiple functional blocks for assisting the driving of the host vehicle 2. The multiple functional blocks constructed by the driving assistance system 1 include a recognition block 100, a planning block 110, and a control block 120, as shown in FIG. 3.

The recognition block 100 acquires sensing information from the sensor system 5. The recognition block 100 acquires communication information from the communication system 6. The recognition block 100 acquires map information stored in the map DB 7. The recognition block 100 acquires, from the memory 10, history data of control commands given by the control block 120 to the host vehicle 2. The recognition block 100 processes the acquired information and data individually and then fuses them to recognize the state of the external and internal environments for each driving scene of the host vehicle 2 and generate recognition data.

Specifically, the recognition block 100 generates recognition data by localization that recognizes the self-status including the self-position of the host vehicle 2. The recognition data related to the status of host vehicle may represent at least one of the following data of the host vehicle 2 in accordance with the control commands from the control block 120: own position (longitude, latitude, and altitude); orientation angle; steering angle; speed; acceleration; jerk; or yaw rate.

The recognition block 100 generates recognition data by recognizing targets existing in the external environment of the host vehicle 2. The targets include other road users 3, obstacles, and structures. The recognition data related to the target may represent at least one of physical quantity of motion, such as a distance, a direction of motion, a relative speed, a relative acceleration, and a time to collision. The recognition data regarding the target may further represent a classification of the target by clustering the data based on the motion physical quantities. The recognition data related to target may be generated so as to provide sensing recognition data for other road users 3 (including the occupants of the road users 3 in the case of the road users are vehicles) recognized by sensing from the external sensor 50 of the host vehicle 2.

The recognition block 100 generates recognition data by recognizing the road on which the host vehicle 2 is traveling. The recognition data related to road may represent at least a type of the road structure. The recognition data related to the road may represent at least one type of road structure, such as the number, position, width, length, shape, curvature of curve, radius of curve, and nodes of the driving lanes and sidewalks on the road. Such road recognition data may be generated so as to provide sensing recognition data regarding the road structure of the driving lanes and sidewalks recognized based on the sensing information sensed by the external sensor 50 of the host vehicle 2.

The recognition block 100 generates the recognition data by recognizing markings associated with the road on which the host vehicle 2 is traveling. The recognition data related to markings may represent at least one type of marking state among road signs, boundary lines, pedestrian crossings, and traffic lights. The recognition data related to markings may further represent at least one of the following traffic rules recognized from the state of the markings: direction of travel; speed limit; or stop positions. Such recognition data related to markings may be generated to provide sensing recognition data related to sign states and traffic rules recognized based on the sensing information sensed by the external sensor 50 of the host vehicle 2.

The recognition block 100 may generate the recognition data by recognizing an operation and/or state of the occupant in the host vehicle 2. The recognition data related to the occupant operation, which gives a manual driving assistance task to the host vehicle 2, may represent at least one of accelerator pedal operation amount, brake pedal operation amount, shift position, steering angle, steering torque, or the like. The recognition data related to the occupant operation to switch the driving task performed to the host vehicle 2 between automated driving task and manual driving assistance task may represent the operation state of at least one of passenger seat switch, such as a task switching switch and an assist switch. Such recognition data related to occupant may be generated to provide sensing recognition data recognized based on the sensing information sensed by the internal sensor 52 of the host vehicle 2.

The planning block 110 obtains the recognition data from the recognition block 100. The planning block 110 acquires history data of control commands to the host vehicle 2 by reading the history data from the memory 10. As shown in FIG. 2, based on the acquired data, the planning block 110 plans a target driving trajectory Td on a planned travel route Rd along which the host vehicle 2 plans to travel.

The driving trajectory Td specifies the time-based changes in the motion parameters targeted as the self-status of the host vehicle 2 for each control period assumed in the future with respect to the current time. The driving trajectory Td may represent the position coordinates of the path that the host vehicle 2 is to follow in the future for each control period. The driving trajectory Td may represent at least one type of physical quantity of motion, such as speed, acceleration, jerk, yaw rate, and yaw angle, as a motion parameter to be generated for each control period on the driving trajectory.

The control block 120 shown in FIG. 3 acquires the recognition data from the recognition block 100. The control block 120 obtains data of the driving trajectory Td from the planning block 110. The control block 120 acquires the history data of control commands output to the host vehicle 2 by reading the history data from the memory 10. The control block 120 generates control commands for the host vehicle 2 based on the acquired data. At this time, a control command to be output to the actuator system 4 is generated so as to control a driving behavior in accordance with the driving automation level. The driving automation level is adjusted according to the driving scene, among the autonomous driving tasks and manual driving assistance tasks of the host vehicle 2. The generated control command data is stored in the memory 10.

For example, a control of driving behavior according to the level of driving automation include a cruise control, which includes lane change assist and/or collision mitigation braking, etc. The cruise control is also referred to as automatic cruise control. The adjustment of driving automation level may include a takeover of the driving task between the driving assistance system 1 and the driver by switching the driving mode between an autonomous driving task and a manual driving assistance task. Such a handover may be performed at least at one of the following times: a time when takeover request is made by the driver; a time when entering or leaving the operational design domain (ODD) of the automated driving; or a time when a minimum risk manoeuvre (MRM) is required.

### (Driving Assistance Flow)

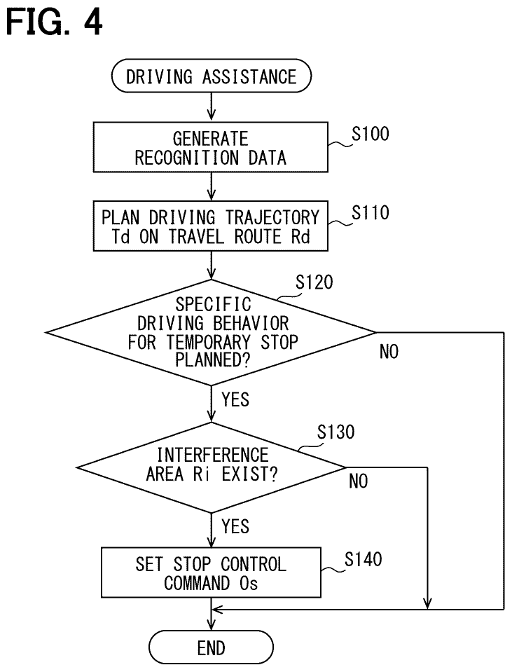

Through cooperation of the blocks 100, 110, and 120 described above, the driving assistance method by which the driving assistance system 1 assists the driving of the host vehicle 2 is repeatedly executed in accordance with the driving assistance flow shown in FIG. 4 during traveling of the host vehicle 2. In the following description, each “S” in the driving assistance flow represents a step executed by an instruction included in the driving assistance program.

In S100, the recognition block 100 generates recognition data that recognizes the status of the external and internal environments in the current driving scene of the host vehicle 2. In S110, the planning block 110 plans the driving trajectory Td of the host vehicle 2 on the travel route Rd for future driving from the current driving scene based on the recognition data generated by at least in S100 of the current flow out of the recognition data generated in current flow and the past flow. The recognition data generated in S100 may be updated as necessary in S120 and thereafter, which will be described later.

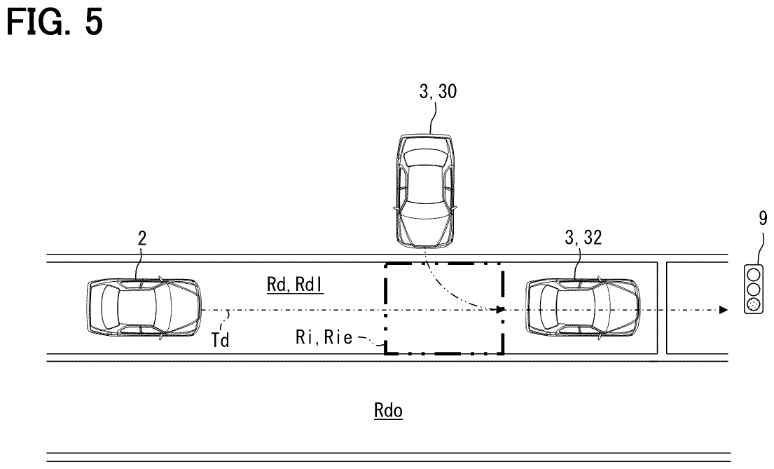

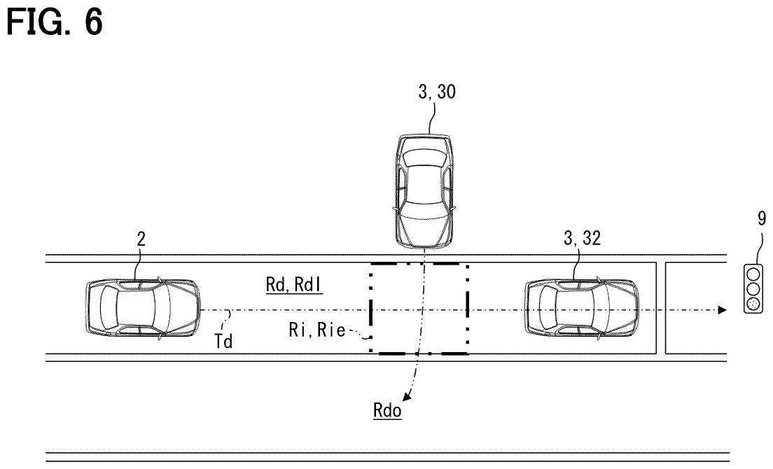

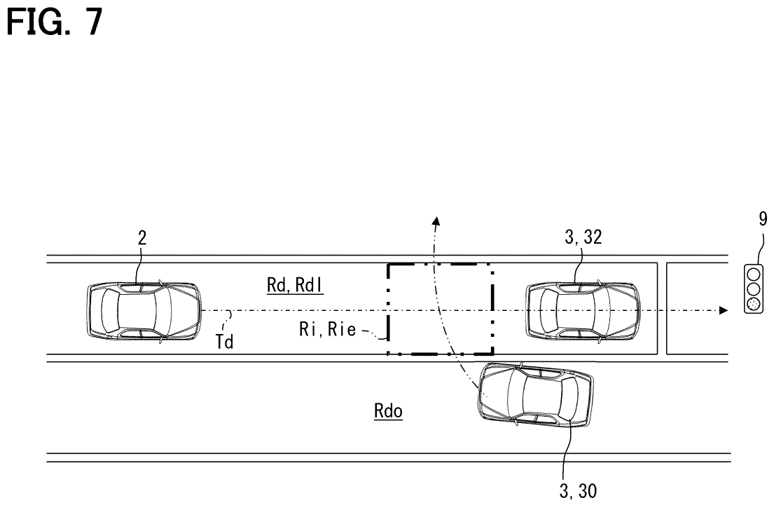

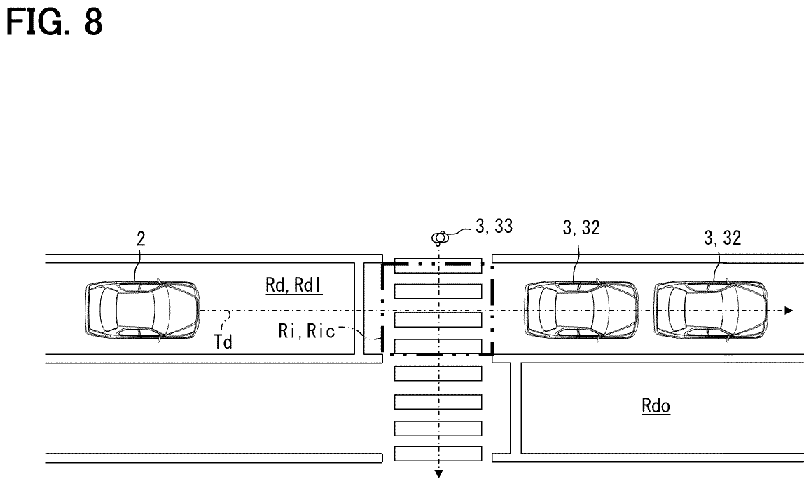

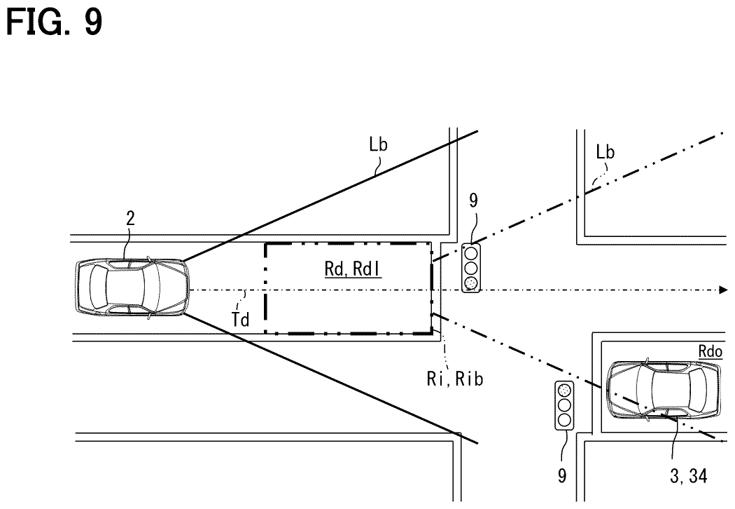

In S120, the control block 120 determines whether the driving trajectory Td on the travel route Rd planned in S110 of the current flow defines a specific driving behavior of the host vehicle 2 in the cruise control state. The cruise control state indicates a driving state in which the host vehicle travels in cruise control mode. The specific driving behavior determined in S120 is a driving behavior in which a temporary stop is planned on the travel route Rd in the cruise control mode following the driving trajectory Td due to, for example, a red light of traffic signal 9 located ahead as shown in FIG. 2, FIG. 5 to FIG. 7, FIG. 9, and/or a traffic jam as shown in FIG. 8.

As shown in FIG. 4, when a negative determination is made in S120, the current flow ends. In S120, when a positive determination is made, the current flow proceeds to S130. In S130, the control block 120 monitors whether an interference area Ri exists on the planned travel route Rd, for which the specific driving behavior is determined in S120 of the current flow. The interference area Ri is an area where the host vehicle 2 may cause an interference to other road users 3 due to a temporary stop. The existence of interference area Ri is monitored based on the recognition data.

Specifically, as shown in FIG. 5 to FIG. 7, a predicted entry area Rie into which a target vehicle 30 corresponding to another road user 3 is predicted to enter may be monitored as the interference area Ri. As described above, the existence of interference area Ri ahead of the host vehicle 2 on the travel route Rd is determined. Suppose that the sensing recognition data represents a facility located ahead the host vehicle 2 along the driving lane Rdl that constitutes the travel route Rd of the host vehicle 2 and a target vehicle 30 on an opposing lane Rdo travels toward the facility to enter the facility. In this case, the predicted entry area Rie is set in an area toward which the target vehicle 30 proceeds. Therefore, the area toward which the target vehicle 30 proceeds, which is located between the host vehicle 2 and a preceding vehicle 32 on the same driving lane Rdl as the host vehicle 2, may be monitored as the predicted entry area Rie. The preceding vehicle 32 is one of the other road users 3. The predicted entry area Rie may be monitored by ensuring a width of predicted travel route for the target vehicle 30 based on the sensing recognition data representing the direction indicators of the target vehicle 30. The predicted entry area Rie may be monitored by adding a safety margin to the width of predicted travel route for the target vehicle 30 based on the sensing recognition data representing the direction indicators of the target vehicle 30.

As shown in FIG. 8, the interference area Ri confirmed to be present ahead of the host vehicle 2 on the travel route Rd may be a predicted crossing area Ric where a target pedestrian 33 is predicted to cross. The target pedestrian 33 is one of other road users 3. Suppose that the sensing recognition data represents a pedestrian crossing located ahead of the host vehicle 2 on the driving lane Rdl that constitutes the travel route Rd of the host vehicle 2 and the target pedestrian 33 moves toward the pedestrian crossing. In this case, the predicted entry area Rie is set in an area toward which the target pedestrian 33 proceeds. Therefore, the area toward which the target pedestrian 33 proceeds or passes, which is located between the host vehicle 2 and the preceding vehicle 32 on the same driving lane Rdl as the host vehicle 2, may be monitored as the predicted entry area Rie. The preceding vehicle 32 is one of the other road users 3.

As shown in FIG. 9 to FIG. 11, in a predicted irradiation scene in which a beam is predicted to be irradiated from the host vehicle 2 on the travel route Rd to an occupant of an oncoming vehicle 34, an irradiation start area Rib defined by a travel position of the host vehicle 2 may be monitored as the interference area Ri. The oncoming vehicle 23 is one of the other road users 3. The predicted irradiation scene is a driving scene in which a low beam Lb is predicted to be irradiated toward the occupant of the oncoming vehicle 34 from a headlight unit of the actuator system 4 in the host vehicle 2 in response to the travel position of the host vehicle reaching the irradiation start area Rib. The irradiation start area Rib is set in the predicted irradiation scene in which the sensing recognition data represents the oncoming vehicle 34 temporarily stops or is predicted to make a temporary stop in front of the host vehicle 2 in the opposing lane Rdo that is parallel to the driving lane Rdl of the host vehicle 2 on the travel route Rd. At this time, the irradiation start area Rib may be monitored with a scenario in which the oncoming vehicle 34 is sensed by the host vehicle 2 during a temporary stop state where a ground contact surface Rds of the tires of the oncoming vehicle 34 on the travel route Rd is lower than that of the host vehicle 2 in the irradiation start area Rib, as the predicted irradiation scene.

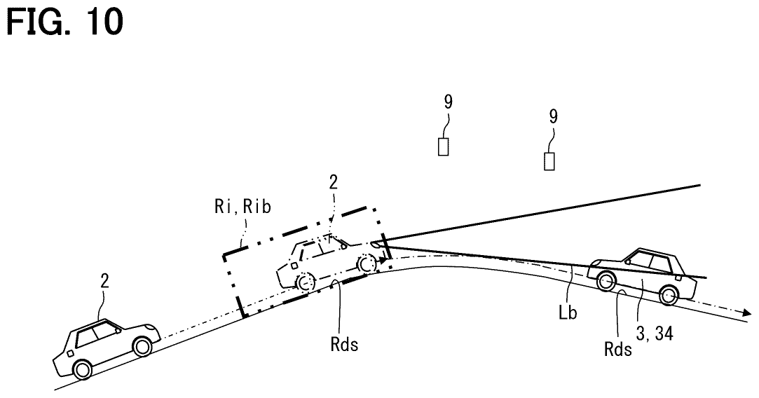

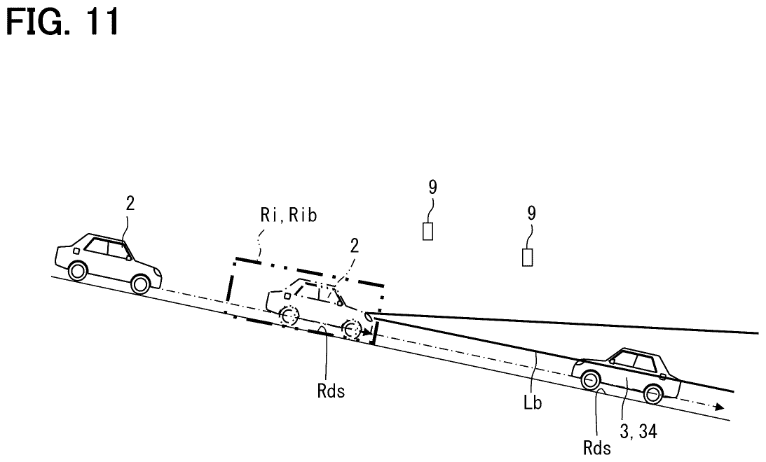

The predicted irradiation scene may be a driving scene in which a red light of traffic signal is predicted to be displayed for both of the host vehicle 2 and the oncoming vehicle 34 from the traffic signal 9 located in a mountain pass area of a road along the travel route Rd of the host vehicle 2 and the ground contact surfaces Rds are inclined as shown in FIG. 10. The predicted irradiation scene may be a driving scene in which a red light is predicted to be displayed for both of host vehicle 2 and oncoming vehicle 34 from the traffic signal 9 located along a road where the ground surface Rds is downhill along the travel route Rd of the host vehicle 2 as shown in FIG. 11.

As shown in FIG. 4, when a negative determination is made in S130, the current flow ends. When a positive determination is made in S130, the current flow proceeds to S140. In S140, the control block 120 sets a stop control command Os for the host vehicle 2 as a control command to temporarily stop the host vehicle 2 at a position before the interference area Ri, which is confirmed in S130 of current flow, on the travel route Rd.

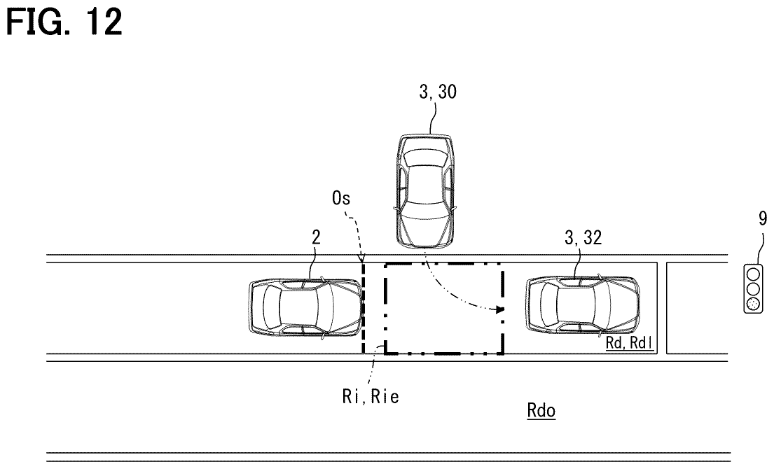

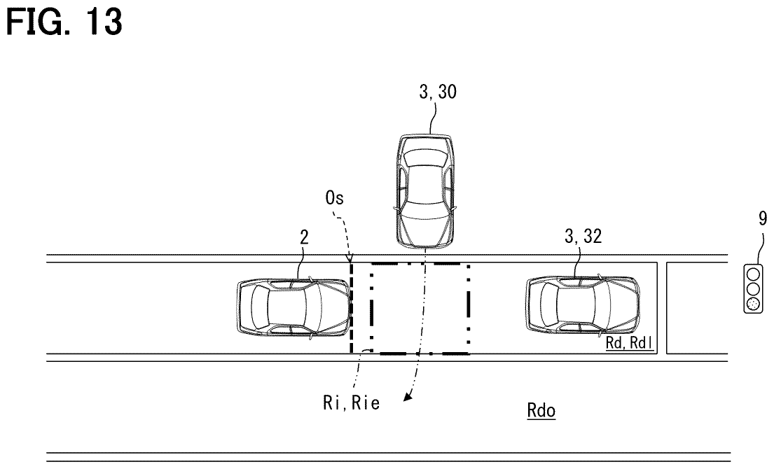

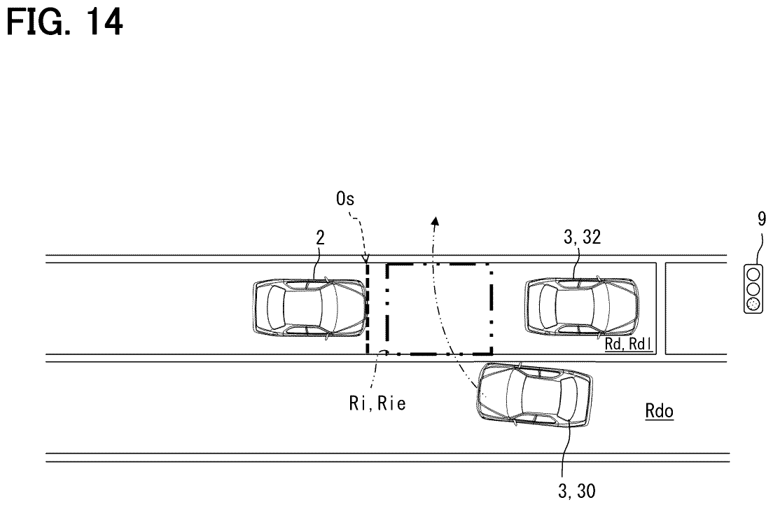

For the predicted entry area Rie that has been confirmed to exist as the interference area Ri on the same driving lane Rdl as the host vehicle 2 as shown in FIG. 12 to FIG. 14, the stop control command Os is set so that interference area Ri is secured ahead of the stop position as an empty space. At this time, in an acceptable scene in which the occupant of the host vehicle 2 can accept an yielding behavior that yields the predicted entry area entry area Rie to the target vehicle 30, the setting of stop control command Os may be executed The acceptable scene is a driving scene in which the sensing recognition information of the recognition data represents at least one of the following: visual recognition of the target vehicle 30 and/or periphery area by the occupant of host vehicle 2; or a gesture by the occupant of the host vehicle 2. With such setting, the predicted entry area Rie can be secured ahead of the temporary stop position, which is set by the stop control command Os, with or without a safety margin as shown in FIG. 12 to FIG. 14.

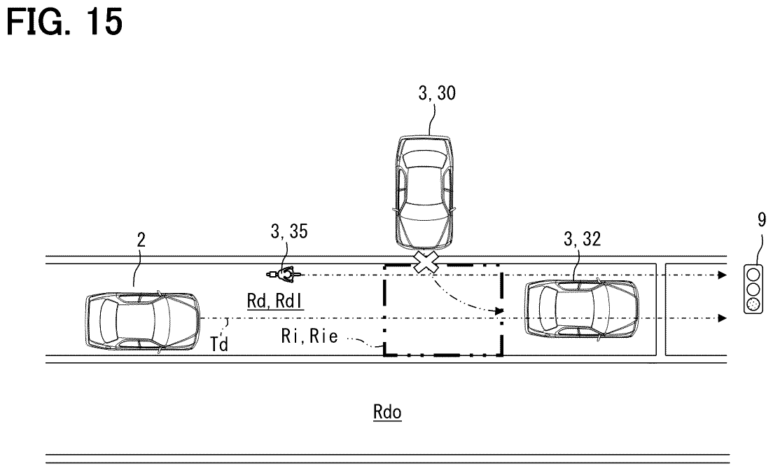

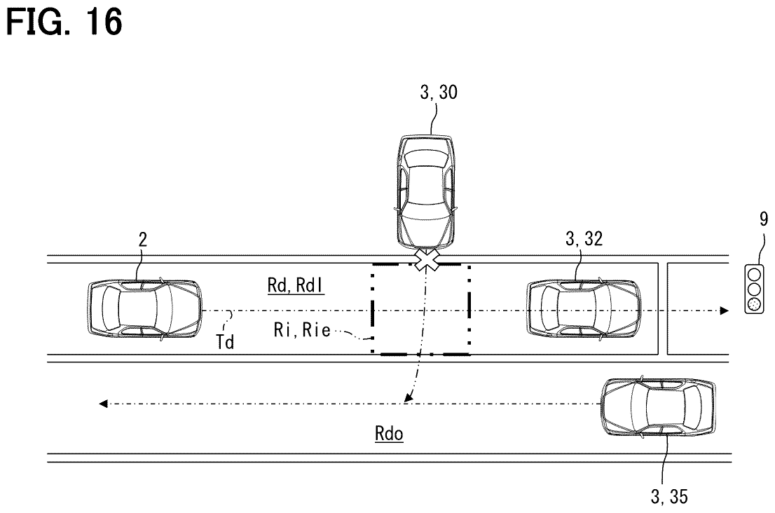

In a prohibited scene other than the above-described acceptable scene for the predicted entry area Rie, setting of the stop control command Os may be prohibited. In the above-described acceptable scene, the setting of stop control command Os may be prohibited when the host vehicle 2 senses a predicted collision user 35, who is predicted to collide with the target vehicle 30, entering the predicted entry area Rie as shown in FIG. 15 and FIG. 16. The predicted collision user is one of the other road users 3. The scene in which the setting of stop control command Os is prohibited as shown in FIG. 15 is a driving scene in which the sensing recognition information represents at least one type of predicted collision user 35, out of a bicycle or a motorcycle, traveling on the same driving lane Rdl as the host vehicle 2 or on a side area of the host vehicle 2. The scene in which the setting of stop control command Os is prohibited as shown in FIG. 16 is a driving scene in which the sensing recognition information represents the predicted collision user 35 travels on the opposing lane Rdo parallel to the driving lane Rdl of the host vehicle 2. The predicted collision user is at least one of the following types of vehicles: an automobile; a truck; a bus; a motorcycle; a bicycle; or the like.

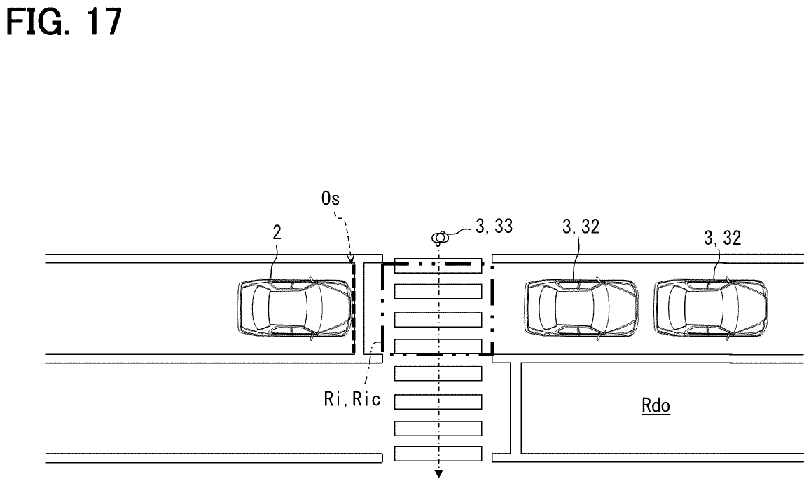

As shown in FIG. 17, for the predicted crossing area Ric that is confirmed to exist as the interference area Ri on the same driving lane Rdl as the host vehicle 2, the stop control command Os is set such that the interference area Ri is secured as an empty space ahead of the stop position set according to the stop control command Os. At this time, in an acceptable scene in which the occupant of the host vehicle 2 can accept an yielding behavior that yields the predicted crossing area Ric to the target pedestrian 33, the setting of stop control command Os may be executed The acceptable scene here is similar to that for the predicted entry area Rie as described above. With such setting, the predicted crossing area Ric can be secured ahead of the temporary stop position, which is set by the stop control command Os, with or without a safety margin as shown in FIG. 17.

In a prohibited scene other than the above-described acceptable scene for the predicted crossing area Ric, setting of the stop control command Os may be prohibited. In a driving scene in which the predicted collision user 35 that may collide with the target pedestrian 33 crossing the predicted crossing area Ric is sensed, the setting of stop control command Os may be executed or prohibited taking into consideration of the response of the predicted collision user 35 to the target pedestrian 33.

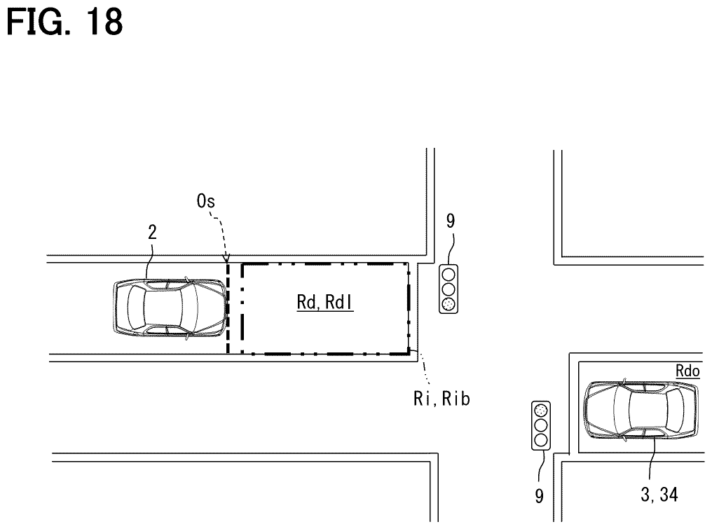

As shown in FIG. 18, for the irradiation start area Rib that is confirmed to exist as the interference area Ri in the same driving lane Rdl as the host vehicle 2, the stop control command Os is set to be secured as an empty space ahead of the stop position set by the stop control command Os. At this time, the execution of temporary stop control to secure the irradiation start area Rib by temporary stop of the host vehicle may be notified to the occupant of host vehicle 2 by the information presentation system 8. The notification may also be performed for the above-described predicted entry area Rie and/or predicted crossing area Ric in the same manner as the irradiation start area Rib as described above. As shown in FIG. 18, the irradiation start area Rib may be secured ahead of the temporary stop position, which is set according to the stop control command Os, with or without a safety margin.

### (Effects)

The effects of the present embodiment will be described below.

According to the present embodiment, a temporary stop of the host vehicle 2 is planned in the cruise control state. The interference area Ri, where interference is predicted to be caused by the host vehicle 2 to the other road user 3 due to a temporary stop of the host vehicle on the travel route Rd in the cruise control state, is monitored. The stop control command Os is set for the host vehicle 2, which travels in the cruise control state, to cause the host vehicle 2 to stop temporarily at a stop position on the travel route Rd before entering the interference area Ri. Thus, it is possible to automatically stop the vehicle with consideration of the interference between the host vehicle and the other road users 3.

According to the present embodiment, the predicted entry area Rie toward which the target vehicle 30, which is one of the other road users 3, is predicted to enter ahead of the host vehicle 2 on the travel route Rd is monitored as the interference area Ri. According to this configuration, the stop control command Os to stop the host vehicle temporarily on the travel route Rd before the predicted entry area Rie can be set for the host vehicle 2 in the cruise control state. Thus, a considerate temporary stop that yields the predicted entry area Rie to the target vehicle 30 can be automatically executed.

According to the present embodiment, the occupant of host vehicle 2, who refuses to accept the yielding behavior of temporary stopping to yield the predicted entry area Rie to the target vehicle 30, may feel uncomfortable with the cruise control in which the host vehicle 2 makes a temporary stop before the predicted entry area Rie. Therefore, by determining the acceptable scene in which it is determined that the occupant of host vehicle 2 is acceptable for yielding the predicted entry area Rie to the target vehicle 30, the stop control command Os may be set to make a temporary stop of the host vehicle before the predicted entry area Rie. Thus, it is possible to improve the user experience of the occupant.

According to the present embodiment, in a driving scene where the predicted collision user 35, who is predicted to collide with the target vehicle 30 planning to enter the predicted entry area Rie, is sensed, the temporary stop of host vehicle 2 before the predicted entry area Rie may cause a further interference. Therefore, in a prohibited scene in which the predicted collision user 35 is sensed by the host vehicle 2, the setting of stop control command Os to temporarily stop the host vehicle before the predicted entry area Rie is prohibited. Thus, it is possible to take into consideration the safety of target vehicle 30 and the predicted collision user 35.

According to the present embodiment, the predicted crossing area Ric where the target pedestrian 33 as one of the other road users 3 is predicted to cross is monitored as the interference area Ri ahead of the host vehicle 2 on the travel route Rd. According to this configuration, the stop control command Os, which temporarily stops the host vehicle on the travel route Rd before the predicted crossing area Ric, can be set for the host vehicle 2 in the cruise control state. Thus, a considerate temporary stop to yield the predicted crossing area Ric to the target pedestrian 33 can be automatically executed.

According to the present embodiment, when the occupant of host vehicle 2 fails to notice the target pedestrian 33, who should be yielded in the predicted crossing area Ric, and fails to perform the yielding behavior, the cruise control can cause the host vehicle 2 to make a temporary stop before the predicted interference entry area Rie. Thus, in the acceptable scene in which the occupant of host vehicle 2 can accept the yielding behavior for yielding the predicted crossing area Ric to the target pedestrian 33, the stop control command Os can be set to temporarily stop the host vehicle before the predicted crossing area Ric. As a result, user experience of the occupant can be improved.

According to the present embodiment, in the predicted irradiation scene in which low beam Lb from the host vehicle 2 is required to be irradiated on the travel route Rd to the occupant of oncoming vehicle 34, the irradiation start area Rib at the travel position of the host vehicle 2 is monitored as the interference area Ri. The oncoming vehicle is one of other road users 3. According to this configuration, the stop control command Os can be set to temporarily stop the host vehicle 2 in cruise control state before the irradiation start area Rib on the travel route Rd, which may cause dazzling to the vision of occupant of oncoming vehicle 34. Thus, a considerate temporary stop can be automatically made to prevent such dazzling.

According to the present embodiment, in the predicted irradiation scene where the host vehicle 2 senses the oncoming vehicle 34, which is in a stopped state with tires contacted on the ground contact surface Rds on the travel route Rd to be lower than that of the host vehicle 2 in the irradiation start area Rib, the irradiation start area Rib is monitored. According to this configuration, the host vehicle 2 in cruise control state can automatically make a temporary stop before the irradiation start area Rib, where the risk of dazzling the vision of the occupant of oncoming vehicle 34 increases due to the difference in elevation of the ground surface Rds. Therefore, it is possible to control the host vehicle with consideration of the safety of oncoming vehicle 34 by monitoring predicted irradiation scene that is highly effective in preventing such dazzling.

### Other Embodiments

Although one embodiment has been described above, the present disclosure is not to be construed as being limited to the embodiment of the description, and can be applied to various embodiments within the scope not departing from the spirit of the present disclosure.

In another modification, a dedicated computer constituting the driving assistance system 1 may include at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In a modified example, the predicted entry area Rie may be a crossing area toward which a bicycle plans to enter as the target vehicle 30. In a modified example, the operator who manually drives the host vehicle 2 to which the driving assistance system 1 is applied may be a remote operator who remotely controls the driving of the host vehicle 2 from a center located outside of the host vehicle. In a modified example, the driving assistance system 1 may be implemented in the automatic driving tasks, that is, driving assistance tasks that assist the operator in manual driving operations do not exist.

What is claimed is:

1. A driving assistance system that assists a driving of a host vehicle with respect to other road users, the driving assistance system comprising
at least one processor with a memory storing computer program code,
wherein the at least one processor with the memory is configured to cause the driving assistance system to:
schedule a temporary stop of the host vehicle in a cruise control state;
monitor an interference area where the host vehicle is predicted to cause an interference to other road users due to a temporary stop on a travel route in the cruise control state; and
set a stop control command to control the host vehicle to make a temporary stop on the travel route before the host vehicle enters the interference area.

2. The driving assistance system according to claim 1, wherein
the at least one processor with the memory is configured to cause the driving assistance system to monitor a predicted entry area to which a target vehicle corresponding to one of other road users plans to enter, as the interference area in front of the host vehicle on the travel route.

3. The driving assistance system according to claim 2, wherein
the at least one processor with the memory is configured to cause the driving assistance system to set the stop control command such that the host vehicle makes the temporary stop before the host vehicle enters the predicted entry area in an acceptable scene, and
the acceptable scene is a driving scene where an occupant of the host vehicle accepts a yielding behavior of temporarily stopping the host vehicle to yield the predicted entry area to the target vehicle.

4. The driving assistance system according to claim 2, wherein
the at least one processor with the memory is configured to cause the driving assistance system to prohibit setting of the stop control command, which controls the host vehicle to make the temporary stop before the host vehicle enters the predicted entry area, in a prohibited scene, and
the prohibited scene is a driving scene where a predicted collision user, who corresponds to one of other road users and is predicted to collide with the target vehicle planning to enter the predicted entry area, is sensed by the host vehicle.

5. The driving assistance system according to claim 1, wherein
the at least one processor with the memory is configured to cause the driving assistance system to monitor a predicted crossing area predicted to be crossed by a target pedestrian corresponding to one of other road users, as the interference area in front of the host vehicle on the travel route.

6. The driving assistance system according to claim 5, wherein
the at least one processor with the memory is configured to cause the driving assistance system to set the stop control command such that the host vehicle makes the temporary stop before the host vehicle enters the predicted crossing area in an acceptable scene, and
the acceptable scene is a driving scene where an occupant of the host vehicle accepts a yielding behavior of temporarily stopping the host vehicle to yield the predicted crossing area to the target pedestrian.

7. The driving assistance system according to claim 1, wherein
the at least one processor with the memory is configured to cause the driving assistance system to monitor, as the interference area, an irradiation start area defined at a travel position of the host vehicle in a predicted irradiation scene, and
the predicted irradiation scene is a driving scene where the host vehicle is predicted to irradiate a low beam on the travel route with respect to an occupant of an oncoming vehicle corresponding to one of other road users.

8. The driving assistance system according to claim 7, wherein
the at least one processor with the memory is configured to cause the driving assistance system to monitor the irradiation start area when the predicted irradiation scene is sensed by the host vehicle, and
in the predicted irradiation scene, the oncoming vehicle is temporarily stopped and a ground contact surface of the oncoming vehicle with the travel route is lower than a ground contact surface of the host vehicle with the travel route in the irradiation start area.

9. A driving assistance method executed by at least one processor to assist a driving of a host vehicle with respect to other road users, the driving assistance method comprising:
scheduling a temporary stop of the host vehicle in a cruise control state;
monitoring an interference area where the host vehicle is predicted to cause an interference to other road users due to a temporary stop on a travel route in the cruise control state; and
setting a stop control command to control the host vehicle to make a temporary stop on the travel route before the host vehicle enters the interference area.

10. A computer-readable non-transitory storage medium storing a driving assistance program for assisting a driving of a host vehicle with respect other road users, the driving assistance program comprising instructions for causing at least one processor to:
schedule a temporary stop of the host vehicle in a cruise control state;
monitor an interference area where the host vehicle is predicted to cause an interference to other road users due to a temporary stop on a travel route in the cruise control state; and
set a stop control command to control the host vehicle to make a temporary stop on the travel route before the host vehicle enters the interference area.
